(19) United States
(12) Patent Application Publication
(10) Pub. No.: US 2024/0166898 A1
(43) Pub. Date: May 23, 2024

(54) INK COMPOSITION, LAYER AND DISPLAY DEVICE USING SAME

(71) Applicant: SAMSUNG SDI CO., LTD., Yongin-si, Gyeonggi-do (KR)

(72) Inventors: Young Woo PARK, Suwon-si (KR); Misun KIM, Suwon-si (KR); Janghyuk KIM, Suwon-si (KR); Dong Wan RYU, Suwon-si (KR); Chuljin PARK, Suwon-si (KR); Eun Sun YU, Suwon-si (KR); Jinsuop YOUN, Suwon-si (KR); Jiyoung JEONG, Suwon-si (KR)

(21) Appl. No.: 18/282,190

(22) PCT Filed: Mar. 17, 2022
(86) PCT No.: PCT/KR2022/003761

§ 371 Date: Sep. 14, 2023

(30) Foreign Application Priority Data
Apr. 7, 2021 (KR) 10-2021-0045452

(51) Int. Cl. C09D 11/037; C09D 5/44; C09D 11/52

(52) U.S. Cl. CPC C09D 11/037; C09D 5/448; C09D 11/52

(57) ABSTRACT

Disclosed are an ink composition, a layer manufactured using the ink composition, and a display device including the same. The ink composition includes (A) semiconductor nanorods; and (B) a mixed solvent that simultaneously satisfies three specific conditions.

### TECHNICAL FIELD

This disclosure relates to an ink composition and a layer and a display device using the same.

### BACKGROUND ART

LEDs have been actively developed since 1992 when Nakamura and others from Japanese Nichia Corp. succeeded in fusing a high-quality single crystal GaN nitride semiconductor by applying a low temperature GaN compound buffer layer. LED is a semiconductor device converting electric signals into light having wavelengths in a desired region by using characteristics of a compound semiconductor, which has a structure that an n-type semiconductor crystal in which a plurality of carriers is electrons and a p-type semiconductor crystal in which a plurality of carriers is holes are combined to each other.

This LED semiconductor has high light conversion efficiency and thus consumes very little energy and has a semi-permanent life-span and also, is environmentally-friendly and thus called to be a revolution of light as a green material. Recently, high luminance red, orange, green, blue, and white LEDs have been developed with the development of compound semiconductor technology and are being applied in many fields such as traffic lights, mobile phones, car headlights, outdoor billboards, LCD BLU (back light unit), and indoor/outdoor lighting, which keeps being actively researched at home and abroad. Particularly, a GaN-based compound semiconductor having a wide bandgap is a material used to manufacture a LED semiconductor emitting light in green, blue, and ultraviolet (UV) regions, and since a blue LED device is used to manufacture a white LED device, lots of research is being made on this.

Among these series of studies, studies using ultra-small LED devices having a nano or micro unit size are being actively conducted, and in addition studies for utilizing these ultra-small LED devices in lighting and displays are being continuously made. In these studies, electrodes capable of applying power to the ultra-small LED devices, disposition of the electrodes for reducing a space occupied by the electrodes, a method of mounting the ultra-small LED devices on the disposed electrodes, and the like are continuously attracting attentions.

Among these, the method of mounting the ultra-small LED devices on the disposed electrodes still have difficulties of disposing and mounting the ultra-small LED devices on the electrodes as intended due to size limitations of the ultra-small LED devices. The reason is that the ultra-small LED devices are nano-scale or micro-scale and thus may not be one by one disposed and mounted by hand on a target electrode region.

Recently, as the demand for the nano-scale ultra-small LED devices is increasing, an attempt to manufacture a nano-scale GaN-based or InGaN-based compound semiconductor into a rod has been made, but the dispersion stability of the nanorods itself in the solvent (or polymerizable compound) may be greatly reduced. And, until now, there has been no introduction of a technology capable of improving dispersion stability of semiconductor nanorods in a solvent (or polymerizable compound). Therefore, research on an ink composition including semiconductor nanorods capable of improving dispersion stability of semiconductor nanorods in a solvent (or polymerizable compound) and realizing high dielectrophoresis rate continues.

### DISCLOSURE

### Technical Problem

An embodiment provides an ink composition having excellent migration properties and storage stability of semiconductor nanorods.

Another embodiment provides a layer manufactured using the ink composition.

Another embodiment provides a display device including the layer.

### Technical Solution

An embodiment provides an ink composition including (A) semiconductor nanorods; and (B) a mixed solvent that simultaneously satisfies the following conditions i), ii), and iii).
i) a dielectric constant of less than or equal to 20,
ii) a viscosity of 60 cps to 110 cps, and
iii) a volatilization temperature of 200° C. to 400° C.

The solvent may include two or more of the compounds represented by Chemical Formula 1 to Chemical Formula 7.

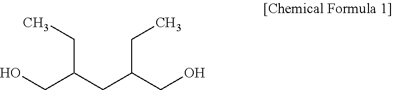

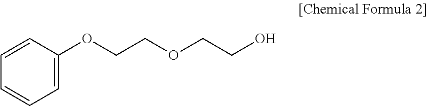 [SMILES: OCCOCCOc1ccccc1]

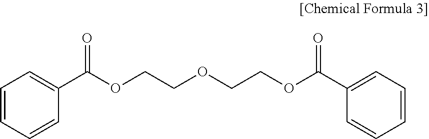 [SMILES: O=C(OCCOCCOC(=O)c1ccccc1)c1ccccc1]

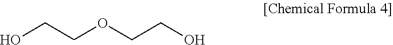

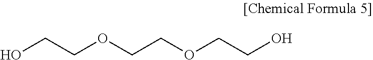

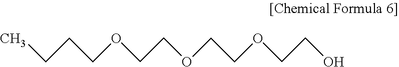

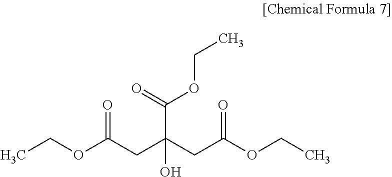 [SMILES: CCOC(=O)CC(O)(CC(=O)OCC)C(=O)OCC]

The semiconductor nanorods may have a diameter of 300 nm to 900 nm.

The semiconductor nanorods may have a length of 3.5 μm to 5 μm.

The semiconductor nanorods may include a GaN-based compound, an InGaN-based compound, or a combination thereof.

The semiconductor nanorods may have a surface coated with a metal oxide.

The metal oxide may include alumina, silica, or a combination thereof.

The semiconductor nanorods may be included in an amount of 0.01 wt % to 10 wt % based on the total amount of the ink composition.

The ink composition may further include malonic acid; 3-amino-1,2-propanediol; a silane-based coupling agent; a leveling agent; a fluorine-based surfactant; or a combination thereof.

The ink composition may be an ink composition for an electrophoresis device.

Another embodiment provides a layer manufactured using the ink composition.

Another embodiment provides a display device including the layer.

Other embodiments of the present invention are included in the following detailed description.

### Advantageous Effects

The ink composition including the semiconductor nanorods according to the embodiment may have excellent migration properties and storage stability.

### DESCRIPTION OF DRAWINGS

FIG. 1 is an example of a cross-sectional view of semiconductor nanorods used in an ink composition according to an embodiment.

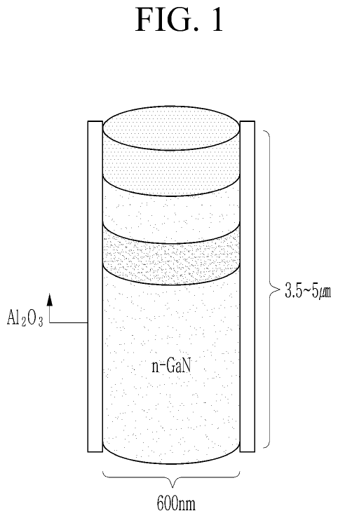

### BEST MODE

Hereinafter, embodiments of the present invention are described in detail. However, these embodiments are exemplary, the present invention is not limited thereto and the present invention is defined by the scope of claims.

As used herein, when specific definition is not otherwise provided, “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C6 to C20 arylalkyl group, “alkylene group” refers to a C1 to C20 alkylene group, “arylene group” refers to a C6 to C20 arylene group, “alkylarylene group” refers to a C6 to C20 alkylarylene group, “heteroarylene group” refers to a C3 to C20 heteroarylene group, and “alkoxylene group” refers to a C1 to C20 alkoxylene group.

As used herein, when specific definition is not otherwise provided, “substituted” refers to replacement of at least one hydrogen by a halogen atom (F, CI, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

As used herein, when specific definition is not otherwise provided, “hetero” refers to one including at least one heteroatom selected from N, O, S and P in a chemical formula.

As used herein, when specific definition is not otherwise provided, “(meth)acrylate” refers to both “acrylate” and “methacrylate”, and “(meth)acrylic” refers to “acrylic” and “methacrylic.”

As used herein, when specific definition is not otherwise provided, “combination” refers to mixing or copolymerization.

As used herein, unless a specific definition is otherwise provided, a hydrogen atom is boned at the position when a chemical bond is not drawn where supposed to be given.

As used herein, “semiconductor nanorods” refers to a rod-shaped semiconductor having a nano-sized diameter.

As used herein, the volatilization temperature means a temperature at which all of the solvent is volatilized.

As used herein, when specific definition is not otherwise provided, “*” indicates a point where the same or different atom or chemical formula is linked.

An ink composition according to an embodiment includes (A) semiconductor nanorods; and (B) a solvent that simultaneously satisfies the following three conditions (i, ii, and iii):
i) a dielectric constant of less than or equal to 20,
ii) a viscosity of 60 cps to 110 cps, and
iii) a volatilization temperature of 200° C. to 400° C.

Recently, studies on various concepts having effects of improving energy efficiency and preventing efficiency drop of conventional LEDs such as micro LED, mini LED, and the like have been actively conducted. Among them, an alignment (electrophoresis) of InGaN-based nanorod LEDs using an electric field draws attentions as a method of dramatically reducing complex and expensive process costs of the micro LED, the mini LED, and the like.

However, organic solvents (PGMEA, GBL, PGME, ethyl acetate, IPA, and the like) conventionally used in a display and an electronic material have low viscosity and thus sedimentation of inorganic nanorod particles having high density may be too fast and thus agglomerated, and in addition, may be fast volatilized and thus may deteriorate alignment characteristics during the solvent drying after the dielectrophoresis. Accordingly, in order to develop an ink composition including the inorganic material nanorods (semiconductor nanorods), a solvent with high viscosity and a high boiling point and thus excellent dielectrophoretic properties is required to improve sedimentation stability of the nanorods, and the inventors of the present invention, after numerous trials and errors, have significantly improved migration properties and particularly, a normal alignment degree of the semiconductor nanorods in the ink composition as well as maintained ink jetting properties of the ink composition and also, realized excellent storage stability by limiting the solvent used with the semiconductor nanorods to a three component system.

Hereinafter, each component is described in detail.

### (A) Semiconductor Nanorods

The semiconductor nanorods may include a GaN-based compound, an InGaN-based compound, or a combination thereof, and the surface thereof may be coated with a metal oxide.

In order to secure dispersion stability of a semiconductor nanorod ink solution (semiconductor nanorods +solvent), it usually takes 3 hours, which is insufficient time to perform a large area inkjet process. Accordingly, the inventors of the present invention have developed an insulating film (Al₂O₃ or SiOₓ) by coating a metal oxide such as alumina, silica, or a combination thereof on the surface of a semiconductor nanorod after numerous trial and error studies to maximize compatibility with a solvent described later.

For example, the insulating film coated with the metal oxide may have a thickness of 40 nm to 60 nm.

The semiconductor nanorods include an n-type confinement layer and a p-type confinement layer, and a multi quantum well (MQW) active region active region may be disposed between the n-type confinement layer and the p-type confinement layer.

For example, the semiconductor nanorods may have a diameter of 300 nm to 900 nm, for example, 600 nm to 700 nm.

For example, the semiconductor nanorods may have a length of 3.5 μm to 5 μm.

For example, when the semiconductor nanorods may include an alumina insulating layer, it may have a density of 5 g/cm³ to 6 g/cm³.

For example, the semiconductor nanorods may have a mass of 1×10⁻¹³ g to 1×10⁻¹¹ g.

When the semiconductor nanorods have the above diameter, length, density and type, the surface coating of the metal oxide may be easily performed, so that dispersion stability of the semiconductor nanorods may be maximized.

The semiconductor nanorods may be included in an amount of 0.01 wt % to 10 wt %, for example 0.01 wt % to 5 wt % based on the total amount of the ink composition. Alternatively, the semiconductor nanorods may be included in an amount of 0.01 parts by weight to 0.5 parts by weight, for example, 0.01 parts by weight to 0.1 parts by weight, based on 100 parts by weight of the solvent in the ink composition. When the semiconductor nanorods are included within the above range, dispersibility in the ink is good, and the prepared pattern may have excellent luminance.

### (B) Solvent

The ink composition according to an embodiment includes a mixed solvent that simultaneously satisfies the above three conditions.

In recent years, as the needs for nano-scale micro LED devices are increasing, there has been an attempt to manufacture a nano-scale GaN-based or InGaN-based compound semiconductor as a rod, but a nanorod itself has a problem that dispersion stability in a solvent (or a polymerizable compound) is greatly deteriorated. Until now, there has been no introduction of a technology of improving the dispersion stability of the semiconductor nanorods in a solvent (or a polymerizable compound).

Organic solvents such as propylene glycol monomethyl ether acetate (PEGMEA), Y-butyrolactone (GBL), polyethylene glycol methyl ether (PGME), ethylacetate, isopropylalcohol (IPA), and the like, which have been used in conventional displays and electron materials have so low viscosity that sedimentation of inorganic nanorod particles with high density are too fast, resulting in unsatisfactory dielectrophoretic properties. Accordingly, as described above, in order to develop an ink composition for an electrophoresis device including an inorganic nanorods (semiconductor nanorods), a solvent capable of imparting sedimentation stability of the nanorods should be used.

Specifically, in order to improve storage stability of the nanorods as well as impart the sedimentation stability of the nanorods, the solvent is controlled to have a dielectric constant of less than or equal to 20 and viscosity of 60 cps to 110 cps and simultaneously, should be all volatilized from the composition at 200° C. to 400° C. during the drying.

Since the solvent in the ink composition according to an embodiment simultaneously satisfies the above conditions for a dielectric constant, a viscosity, and a volatilization temperature, the nanorods may have a normal alignment degree of greater than or equal to 80% and storage stability of greater than or equal to 7 hours.

For example, the solvent may include two or more of the compounds represented by Chemical Formula 1 to Chemical Formula 7.

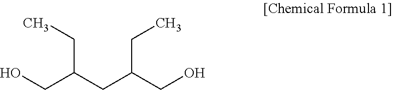

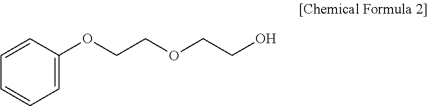 [SMILES: OCCOCCOc1ccccc1]

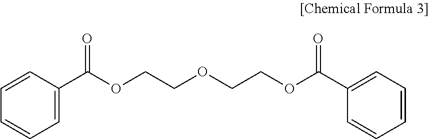 [SMILES: O=C(OCCOCCOC(=O)c1ccccc1)c1ccccc1]

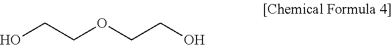

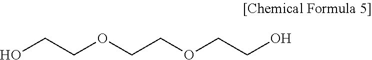

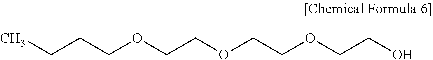

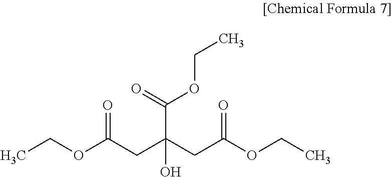 [SMILES: CCOC(=O)CC(O)(CC(=O)OCC)C(=O)OCC]

The solvent may be included in an amount of 15 wt % to 99.99 wt %, for example 20 wt % to 99.7 wt % based on the total amount of the ink composition.

### Polymerizable Monomer

The ink composition according to an embodiment may further include a polymerizable compound. The polymerizable compound may be used by mixing monomers or oligomers that are generally used in conventional curable compositions.

For example, the polymerizable compound may be a polymerizable monomer having a carbon-carbon double bond at the terminal end.

For example, the polymerizable compound may be a polymerizable monomer having at least one of the functional group represented by Chemical Formula A-1 or the functional group represented by Chemical Formula A-2 at the terminal end.

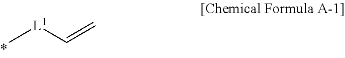

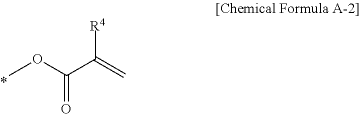

In Chemical Formula A-1 and Chemical Formula A-2,

L¹ is a substituted or unsubstituted C1 to C20 alkylene group, and

R⁴ is a hydrogen atom or a substituted or unsubstituted C1 to C20 alkyl group.

The polymerizable compound may form a crosslinked structure with the surface-modified compound by including at least one carbon-carbon double bond, specifically the functional group represented by Chemical Formula A-1 or the functional group represented by Chemical Formula A-2. The product having the crosslinked structure may further improve dispersion stability of the semiconductor nanorods by doubling a type of steric hindrance effect.

For example, examples of the polymerizable compound including at least one functional group represented by Chemical Formula A-1 at the terminal end may include divinyl benzene, triallyl cyanurate, triallyl isocyanurate, triallyl trimellitate, triallyl phosphate, triallyl phosphite, triallyl triazine, diallyl phthalate, or a combination thereof, but is not necessarily limited thereto.

For example, the polymerizable compound including at least one functional group represented by Chemical Formula A-2 at the terminal end may include ethylene glycol diacrylate, triethylene glycoldiacrylate, 1,4-butanedioldiacrylate, 1,6-hexanedioldiacrylate, neopentylglycoldiacrylate, pentaerythritoldiacrylate, pentaerythritoltriacrylate, dipentaerythritoldiacrylate, dipentaerythritoltriacrylate, dipentaerythritolpentaacrylate, pentaerythritolhexaacrylate, bisphenol A diacrylate, trimethylolpropanetriacrylate, novolacepoxyacrylate, ethylene glycoldimethacrylate, diethylene glycoldimethacrylate, triethylene glycoldimethacrylate, propylene glycoldimethacrylate, 1,4-butanedioldimethacrylate, 1,6-hexanedioldimethacrylate, multi-functional epoxy(meth) acrylate, multi-functional urethane(meth)acrylate, KAYARAD DPCA-20, KAYARAD DPCA-30, KAYARAD DPCA-60, KAYARAD DPCA-120, KAYARAD DPEA-12, or a combination thereof manufactured by Japan Chemical Co., Ltd., but is not necessarily limited thereto.

The polymerizable compound may be treated with an acid anhydride in order to impart more excellent developability.

### Polymerization Initiator

The ink composition according to the embodiment may further include a polymerization initiator, for example, a photopolymerization initiator, a thermal polymerization initiator, or a combination thereof.

The photopolymerization initiator may be an initiator generally used in curable compositions, for example, an acetophenone-based compound, a benzophenone-based compound, a thioxanthone-based compound, a benzoin-based compound, a triazine-based compound, an oxime-based compound, and an aminoketone-based compound, but is not necessarily limited thereto.

Examples of the acetophenone-based compound may be 2,2′-diethoxy acetophenone, 2,2′-dibutoxy acetophenone, 2-hydroxy-2-methylpropinophenone, p-t-butyltrichloro acetophenone, p-t-butyldichloro acetophenone, 4-chloro acetophenone, 2,2′-dichloro-4-phenoxy acetophenone, 2-methyl-1 -(4-(methylthio)phenyl)-2-morpholinopropan-1-one, 2-benzyl-2-dimethylamino-1-(4-morpholinophenyl)-butan-1-one, and the like.

Examples of the benzophenone-based compound may include benzophenone, benzoyl benzoate, benzoyl methyl benzoate, 4-phenyl benzophenone, hydroxybenzophenone, acrylated benzophenone, 4,4′-bis(dimethylamino)benzophenone, 4,4′-bis(diethylamino)benzophenone, 4,4′-dimethylam inobenzophenone, 4,4′-dichlorobenzophenone, 3,3′-dimethyl-2-methoxybenzophenonem, and the like.

Examples of the thioxanthone-based compound may be thioxanthone, 2-methylthioxanthone, isopropyl thioxanthone, 2,4-diethyl thioxanthone, 2,4-diisopropyl thioxanthone, 2-chlorothioxanthone, and the like.

Examples of the benzoin-based compound may be benzoin, benzoin methyl ether, benzoin ethyl ether, benzoin isopropyl ether, benzoin isobutyl ether, benzyldimethylketal, and the like.

Examples of the triazine-based compound may be 2,4,6-trichloro-s-triazine, 2-phenyl-4,6-bis(trichloromethyl)-s-triazine, 2-(3′,4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-biphenyl-4,6-bis(trichloro methyl)-s-triazine, bis(trichloromethyl)-6-styryl-s-triazine, 2-(naphtho-1-yl)-4,6-bis(trichloromethyl)-s-triazine, 2-(4-methoxynaphtho-1-yl)-4,6-bis(trichloromethyl)-s-triazine, 2-4-bis(trichloromethyl)-6-piperonyl-s-triazine, 2-4-bis(trichloromethyl)-6-(4-methoxystyryl)-s-triazine, and the like.

Examples of the oxime compound may include an O-acyloxime compound, 2-(O-benzoyloxime)-1-[4-(phenylthio)phenyl]-1,2-octanedione, 1-(O-acetyloxime)-1-[9-ethyl-6-(2-methylbenzoyl)-9H-carbazol-3-yl]ethanone, O-ethoxycarbonyl-α-oxyamino-1-phenylpropan-1-one, and the like. Specific examples of the O-acyloxime-based compound may include 1,2-octanedione, 2-dimethylamino-2-(4-methylbenzyl)-1-(4-morpholin-4-yl-phenyl)-butane-1-one, 1-(4-phenylsulfanylphenyl)-butane-1,2-dione-2-oxime-O-benzoate, 1-(4-phenylsulfanylphenyl)-octane-1,2-dione -2-oxime-O-benzoate, 1-(4-phenylsulfanylphenyl)-octan-1-oneoxime-O-acetate, 1-(4-phenylsulfanylphenyl)-butan-1-oneoxime-O-acetate, and the like.

Examples of the am inoketone-based compound may include 2-benzyl-2-dimethylamino-1-(4-morpholinophenyl)-butanone-1.

The photopolymerization initiator may further include a carbazole-based compound, a diketone-based compound, a sulfonium borate-based compound, a diazo-based compound, an imidazole-based compound, a biimidazole-based compound, and the like, besides the compounds.

The photopolymerization initiator may be used with a photosensitizer capable of causing a chemical reaction by absorbing light and becoming excited and then, transferring its energy.

Examples of the photosensitizer may be tetraethylene glycol bis-3-mercapto propionate, pentaerythritol tetrakis-3-mercapto propionate, dipentaerythritol tetrakis-3-mercapto propionate, and the like.

Examples of the thermal polymerization initiator may be peroxide, specifically, benzoyl peroxide, dibenzoyl peroxide, lauryl peroxide, dilauryl peroxide, di-tert-butyl peroxide, cyclohexane peroxide, methyl ethyl ketone peroxide, hydroperoxide (e.g., tert-butyl hydroperoxide, cumene hydroperoxide), dicyclohexyl peroxydicarbonate, 2,2-azo-bis(isobutyronitrile), t-butyl perbenzoate, and the like and also, 2,2′-azobis-2-methylpropinonitrile and the like, but are not necessarily limited thereto and may include anything widely known in the related field.

The polymerization initiator may be included in an amount of 1 wt % to 5 wt %, for example 2 wt % to 4 wt % based on the total solid amount of the ink composition. When the polymerization initiator is included within the ranges, the ink composition may be sufficiently cured during the exposure or thermal curing and thus obtain excellent reliability.

### Other Additives

The ink composition according to an embodiment may further include a polymerization inhibitor including a hydroquinone-based compound, a catechol-based compound, or a combination thereof. As the ink composition according to an embodiment further includes the hydroquinone-based compound, catechol-based compound, or combination thereof, after printing (coating) an ink composition, crosslinking at room temperature may be prevented during exposure.

For example, the hydroquinone-based compound, catechol-based compound, or combination thereof may include hydroquinone, methyl hydroquinone, methoxyhydroquinone, t-butyl hydroquinone, 2,5-di-t-butyl hydroquinone, 2,5-bis(1,1-dimethylbutyl) hydroquinone, 2,5-bis(1,1,3,3-tetramethylbutyl) hydroquinone, catechol, t-butyl catechol, 4-methoxyphenol, pyrogallol, 2,6-di-t-butyl-4-methylphenol, 2-naphthol, tris(N-hydroxy-N-nitrosophenylaminato-O,O′) aluminium, or a combination thereof, but is not necessarily limited thereto.

The hydroquinone-based compound, catechol-based compound, or combination thereof may be used in a dispersion type and the dispersion-type polymerization inhibitor may be included in an amount of 0.001 wt % to 1 wt %, for example 0.01 wt % to 0.1 wt %, based on the total amount of the ink composition. When the stabilizer is included within the above range, the problem with aging at room temperature may be solved and sensitivity reduction and surface peeling may be prevented.

The ink composition according to an embodiment may further include malonic acid; 3-amino-1,2-propanediol; a silane-based coupling agent; a leveling agent; a fluorine-based surfactant; or a combination thereof in addition to the polymerization inhibitor.

For example, the ink composition may further include a silane coupling agent having a reactive substituent such as a carboxyl group, a methacryloyl group, an isocyanate group, an epoxy group, and the like to improve its adherence to a substrate.

Examples of the silane-based coupling agent may include trimethoxysilyl benzoic acid, γ-methacryl oxypropyl trimethoxysilane, vinyl triacetoxysilane, vinyl trimethoxysilane, γ-isocyanate propyl triethoxysilane, γ-glycidoxy propyl trimethoxysilane, β-epoxycyclohexypethyl trimethoxysilane, and the like. These may be used alone or in a mixture of two or more.

The silane-based coupling agent may be included in an amount of 0.01 parts by weight to 10 parts by weight based on 100 parts by weight of the ink composition. When the silane-coupling agent is included within the range, close contacting property, storing property, and the like may be improved.

In addition, the ink composition may further include a surfactant, for example a fluorine-based surfactant to improve coating and prevent a defect if necessary.

Examples of the fluorine-based surfactant may be BM-1000® and BM-1100® of BM Chemie Inc.; MEGAFACE F 142D®, MEGAFACE F 172®, MEGAFACE F 173®, and MEGAFACE F 183® of Dainippon Ink Kagaku Kogyo Co., Ltd.; FULORAD FC-135®, FULORAD FC-170C®, FULORAD FC-430®, and FULORAD FC-431® of Sumitomo 3M Co., Ltd.; SURFLON S-112®, SURFLON S-113®, SURFLON S-131®, SURFLON S-141®, and SURFLON S-145® of ASAHI Glass Co., Ltd.; and SH-28PP®, SH-190®, SH-193®, SZ-6032® and SF-8428®, and the like of Toray Silicone Co., Ltd.; F-482, F-484, F-478, F-554, and the like of DIC Co., Ltd.

The fluorine-based surfactant may be included in an amount of 0.001 parts by weight to 5 parts by weight based on 100 parts by weight of the ink composition. When the fluorine-based surfactant is included within the above range, excellent wetting on a glass substrate as well as coating uniformity may be secured, and a stain may not be produced.

In addition, a certain amount of other additives such as antioxidants and stabilizers may be further added to the ink composition within a range that does not impair physical properties.

Another embodiment provides a layer using the ink composition.

Another embodiment provides a display device including the layer, and for example the display device may be an electrophoresis device.

### MODE FOR INVENTION

Hereinafter, the present invention is illustrated in more detail with reference to examples. These examples, however, are not in any sense to be interpreted as limiting the scope of the invention.

### Preparation of Ink Composition

### Examples 1 to 8 and Comparative Examples 1 to 12

A nanorod-patterned InGaN wafer (4 inches) was reacted in 40 ml of stearic acid (1.5 mM) at room temperature for 24 hours. After the reaction, the nanorod-patterned InGaN was dipped in 50 ml of acetone for 5 minutes to remove an excess amount of the stearic acid, and additionally, 40 ml of acetone was used to rinse the surface of the wafer. The washed wafer was placed with 35 ml of γ-butyrolactone (GBL) in a 27 kW bath-type sonicator and then, sonicated for 5 minutes to separate the rods from the wafer surface. The separated rods were placed in a FALCON tube for a centrifuge, and 10 ml of GBL was added thereto to additionally wash the rods on the surface of the bath.

Then, a supernatant was discarded therefrom through centrifugation at 4000 rpm for 10 minutes, and precipitates therein were redispersed in 40 ml of acetone and filtered with a 10 μm mesh filter. After additional centrifugation (4000 rpm, 10 minutes), the precipitate was dried in a drying oven (100° C. for 1 hour), weighed, and dispersed to be 0.05 w/w % to prepare each ink composition having compositions shown in Table 1.

(The composition of the mixed solvent and the dielectric constant, viscosity, and volatilization temperature of the solvent are shown in Tables 2 and 3.)

TABLE 1
(unit: wt %)

| | | | Amount |
|---|---|---|---|
| (A) InGaN nanorods | | | 0.05 |
| (B) Mixed solvent | | | 99.8 |
| (C) Other | (C-1) | Fluorine-based surfactant (F-554, DIC Co., | 0.07 |
| additives | | Ltd.) | |
| | (C-2) | Polymerization inhibitor | 0.08 |
| | | (methylhydroquinone) (Tokyo Chemical | |
| | | Industry Co., Ltd.) | |

TABLE 2

| Mixed solvent | Ex. 1 | Ex. 2 | Ex. 3 | Ex. 4 | Ex. 5 | Ex. 6 | Ex. 7 | Ex. 8 |
|---|---|---|---|---|---|---|---|---|
| Dielectric constant | 17 | 10 | 3 | 20 | 20 | 17 | 13 | 9 |
| Volatilization | 325 | 294 | 300 | 261 | 274 | 202 | 200 | 400 |
| temperature (° C.) | | | | | | | | |
| Viscosity (cps) | 95 | 88 | 103 | 66 | 60 | 110 | 83 | 63 |
| Solvent | Chemical | Chemical | Chemical | Chemical | Chemical | Chemical | Chemical | Chemical |
| composition (wt %) | Formula 1 | Formula 1 | Formula 1 | Formula 1 | Formula 1 | Formula 1 | Formula 1 | Formula 1 |
| | (55) | (50) | (50) | (40) | (40) | ( 50) | (50) | (30) |
| | Chemical | Chemical | Chemical | Chemical | Chemical | Chemical | Chemical | Chemical |
| | Formula 2 | Formula 2 | Formula 2 | Formula 2 | Formula 2 | Formula 2 | Formula 2 | Formula 2 |
| | (8) | (10) | (10) | (17) | (20) | (9) | (9.8) | (15) |
| | Chemical | Chemical | Chemical | | | | | Chemical |
| | Formula 3 | Formula 3 | Formula 3 | | | | | Formula 3 |
| | (20) | (20) | (20) | | | | | (30) |
| | Chemical | | | Chemical | | | | |
| | Formula 4 | | | Formula 4 | | | | |
| | (3) | | | (3) | | | | |
| | | | | Chemical | Chemical | Chemical | | |
| | | | | Formula 5 | Formula 5 | Formula 5 | | |
| | | | | (10) | (10) | (5) | | |
| | Chemical | Chemical | Chemical | Chemical | Chemical | Chemical | Chemical | Chemical |
| | Formula 6 | Formula 6 | Formula 6 | Formula 6 | Formula 6 | Formula 6 | Formula 6 | Formula 6 |
| | (5) | (10.8) | (10) | (10) | (10) | (16) | (20) | (10) |
| | Chemical | Chemical | Chemical | Chemical | Chemical | Chemical | Chemical | Chemical |
| | Formula 7 | Formula 7 | Formula 7 | Formula 7 | Formula 7 | Formula 7 | Formula 7 | Formula 7 |
| | (5) | (9) | (9.8) | (10) | (10) | (16) | (20) | (10) |
| | | | | Propylene | Propylene | Propylene | | |
| | | | | Glycol | Glycol | Glycol | | |
| | | | | Phenyl | Phenyl | Phenyl | | |
| | | | | Ether | Ether | Ether | | |
| | | | | (5) | (9.8) | (3.8) | | |
| | Triethylene | | | Triethylene | | | | |
| | Glycol | | | Glycol | | | | |
| | monobutyl | | | monobutyl | | | | |
| | Ether | | | Ether | | | | |
| | (3.8) | | | (4.8) | | | | |
| | | | | | | | | Oleic Acid |
| | | | | | | | | (4.8) |

TABLE 3

| | Comp. | Comp. | Comp. | Comp. | Comp. | Comp. |
|---|---|---|---|---|---|---|
| Mixed solvent | Ex. 1 | Ex. 2 | Ex. 3 | Ex. 4 | Ex. 5 | Ex. 6 |
| Dielectric constant | 8 | 10 | 11 | 25 | 8 | 12 |
| Volatilization | 150 | 270 | 300 | 385 | 180 | 351 |
| temperature (° C.) | | | | | | |
| Viscosity (cps) | 0.8 | 14 | 35 | 80 | 100 | 120 |
| Solvent | Chemical | Chemical | Chemical | Chemical | Chemical | Chemical |
| composition (wt %) | Formula 1 | Formula 1 | Formula 1 | Formula 1 | Formula 1 | Formula 1 |
| | (5) | (3) | (5) | (10) | (30) | (45) |
| | | Chemical | Chemical | Chemical | | Chemical |
| | | Formula 3 | Formula 3 | Formula 3 | | Formula 3 |
| | | (3) | (5) | (20) | | (10) |
| | | | | Chemical | | |
| | | | | Formula 4 | | |
| | | | | (13) | | |
| | | Chemical | Chemical | Chemical | Chemical | |
| | | Formula 6 | Formula 6 | Formula 6 | Formula 6 | |
| | | (15) | (20) | (13) | (20) | |
| | Chemical | Chemical | Chemical | Chemical | Chemical | |
| | Formula 7 | Formula 7 | Formula 7 | Formula 7 | Formula 7 | |
| | (5) | (3) | (3) | (3) | (5) | |
| | | | | | | Triethyl |
| | | | | | | 2-acetyl |
| | | | | | | citrate |
| | | | | | | (5) |
| | Propylene | Propylene | Propylene | Propylene | Propylene | Propylene |
| | Glycol | Glycol | Glycol | Glycol | Glycol | Glycol |
| | mono-methyl | monomethyl | monomethyl | monomethyl | monomethyl | monomethyl |
| | ether | ether | ether | ether | ether | ether |
| | acetate | acetate | acetate | acetate | acetate | acetate |
| | (89.9) | (75.8) | (66.8) | (40.8) | (44.8) | (39.8) |

| | Comp. | Comp. | Comp. | Comp. | Comp. | Comp. |
|---|---|---|---|---|---|---|
| Mixed solvent | Ex. 7 | Ex. 8 | Ex. 9 | Ex. 10 | Ex. 11 | Ex. 12 |
| Dielectric constant | 12 | 21 | 19 | 18 | 12 | 15 |
| Volatilization | 300 | 287 | 313 | 306 | 195 | 405 |
| temperature (° C.) | | | | | | |
| Viscosity (cps) | 120 | 61 | 55 | 115 | 75 | 92 |
| Solvent | Chemical | Chemical | Chemical | Chemical | Chemical | Chemical |
| composition (wt %) | Formula 1 | Formula 1 | Formula 1 | Formula 1 | Formula 1 | Formula 1 |
| | (45) | (30) | (20) | (70.8) | (60) | (75) |
| | | Chemical | Chemical | Chemical | Chemical | Chemical |
| | | Formula 2 | Formula 2 | Formula 2 | Formula 2 | Formula 2 |
| | | (3) | (5) | (3) | (5) | (3) |
| | | Chemical | Chemical | Chemical | | Chemical |
| | | Formula 3 | Formula 3 | Formula 3 | | Formula 3 |
| | | (3) | (5) | (20) | | (8) |
| | Chemical | | | | | |
| | Formula 4 | | | | | |
| | (10) | | | | | |
| | | Chemical | Chemical | | | |
| | | Formula 5 | Formula 5 | | | |
| | | (58.8) | (49.8) | | | |
| | | Chemical | Chemical | Chemical | Chemical | Chemical |
| | | Formula 6 | Formula 6 | Formula 6 | Formula 6 | Formula 6 |
| | | (2) | (5) | (3) | (5) | (3) |
| | | Chemical | Chemical | Chemical | Chemical | Chemical |
| | | Formula 7 | Formula 7 | Formula 7 | Formula 7 | Formula 7 |
| | | (3) | (15) | (3) | (29.8) | (10.8) |
| | Triethyl | | | | | |
| | 2-acetyl | | | | | |
| | citrate | | | | | |
| | (5) | | | | | |
| | Propylene | | | | | |
| | Glycol | | | | | |
| | monomethyl | | | | | |
| | ether | | | | | |
| | acetate | | | | | |
| | (39.8) | | | | | |

* A dielectric constant of each mixed solvent was measured at room temperature (25° C.) by putting 40 ml of each solvent composition according to the examples and the comparative examples in a conical tube and using a liquid dielectric constant-measuring device (Model 871, Furuto Industrial Co., Ltd.), and a viscosity was measured at room temperature (25° C.) by loading 2 ml of the solvent compositions and using a rheometer (Haake Technik GmbH).

### Evaluation: Dielectrophoretic Properties and Storage Stability

(1) Dielectrophoretic Properties 500 μl of the ink compositions according to Examples 1 to 8 and

Comparative Examples 1 to 12 were respectively coated on a thin-film gold basic interdigitated linear electrode (ED-cIDE4-Au, Micrux Technologies) and after applying an electric field (25 KHz, ±30 v) thereto, waited for 1 minute. Subsequently, the solvents were dried by using a hot plate and then, examined with a microscope to count the number (ea) of aligned nanorod particles and the number (ea) of nonaligned nanorod particles in the center between electrodes and thus evaluate dielectrophoretic properties, and the results are shown in Tables 4 and 5.

### (2) Storage Stability

The ink compositions according to Examples 1 to 8 and Comparative Examples 1 to 12 were respectively taken by 10 ml and placed in a test tube (diameter: 1 cm, height: 13 cm) and then, measured with respect to time at which bottom precipitates were generated at room temperature (25° C.), and the results are shown in Tables 4 and 5.

TABLE 4

| | Exam- | Exam- | Exam- | Exam- | Exam- | Exam- | Exam- | Exam- |
|---|---|---|---|---|---|---|---|---|
| | ple 1 | ple 2 | ple 3 | ple 4 | ple 5 | ple 6 | ple 7 | ple 8 |
| Dielectrophoresis (%) | 91 | 95 | 93 | 82 | 83 | 81 | 90 | 82 |
| Storage stability (hr) | >7 | >7 | >7 | >7 | >7 | >7 | >7 | >7 |

TABLE 5

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Dielectrophoresis (%) | 20 | 85 | 88 | 55 | 52 | 95 |
| Stability (hr) | <1 | <3 | <4 | <6 | >7 | >7 |
| | Comparative | Comparative | Comparative | Comparative | Comparative | Comparative |
| | Example 7 | Example 8 | Example 9 | Example 10 | Example 11 | Example 12 |
| Dielectrophoresis (%) | 95 | 75 | 78 | 95 | 48 | 42 |
| Stability (hr) | >7 | >7 | <6 | >7 | >7 | >7 |

As shown in Tables 4 and 5, Examples 1 to 8 exhibited excellent dielectrophoretic properties and storage stability, compared to Comparative Examples 1 to 12.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

1. An ink composition, comprising:
(A) semiconductor nanorods; and
(B) a mixed solvent that simultaneously satisfies the following conditions i), ii),
i) a dielectric constant of less than or equal to 20,
ii) a viscosity of 60 cps to 110 cps, and
iii) a volatilization temperature of 200° C. to 400° C.

2. The ink composition of claim 1, wherein the solvent comprises two or more of the compounds represented by Chemical Formula 1 to Chemical Formula 7:

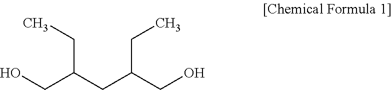

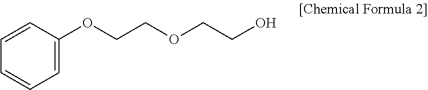 [SMILES: OCCOCCOc1ccccc1]

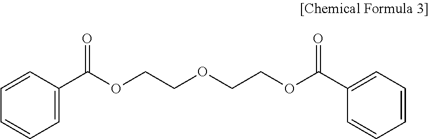 [SMILES: O=C(OCCOCCOC(=O)c1ccccc1)c1ccccc1]

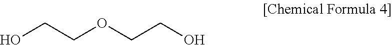

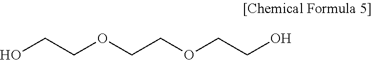

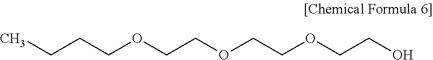

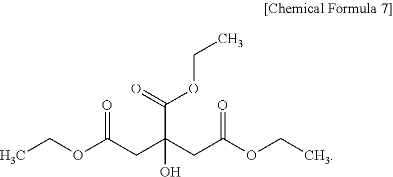 [SMILES: CCOC(=O)CC(O)(CC(=O)OCC)C(=O)OCC]

3. The ink composition of claim 1, wherein the semiconductor nanorods have a diameter of 300 nm to 900 nm.

4. The ink composition of claim 1, wherein the semiconductor nanorods have a length of 3.5 μm to 5 μm.

5. The ink composition of claim 1, wherein the semiconductor nanorods comprise a GaN-based compound, an InGaN-based compound, or a combination thereof.

6. The ink composition of claim 1, wherein the semiconductor nanorods have a surface coated with a metal oxide.

7. The ink composition of claim 6, wherein the metal oxide comprises alumina, silica, or a combination thereof.

8. The ink composition of claim 1, wherein the semiconductor nanorods are included in an amount of 0.01 wt % to 10 wt % based on the total amount of the ink composition.

9. The ink composition of claim 1, wherein the ink composition further comprises malonic acid; 3-amino-1,2-propanediol; a silane-based coupling agent; a leveling agent; a fluorine-based surfactant; or a combination thereof.

10. The ink composition of claim 1, wherein the ink composition is an ink composition for an electrophoresis device.

11. A layer manufactured using the ink composition of claim 1.

12. A display device comprising the layer of claim 11.
